(19) United States
(12) Patent Application Publication
(10) Pub. No.: US 2024/0346364 A1
(43) Pub. Date: Oct. 17, 2024

(54) Co-attentive Fusion with Unified Label Graph Representation for Low-resource Text Classification

(71) Applicant: Robert Bosch GmbH, Stuttgart (DE)

(72) Inventor: Jun Araki, San Jose, CA (US)

(21) Appl. No.: 18/299,342

(22) Filed: Apr. 12, 2023

(51) Int. Cl. G06N 20/00; G06F 40/284; G06F 40/30

(52) U.S. Cl. CPC G06N 20/00; G06F 40/284; G06F 40/30

(57) ABSTRACT

A text classification framework is disclosed, referred to as Co-attentive Fusion with Unified Label Graph Representation (CoFuLaG). The text classification framework is a two-stage process. In a first stage, a unified label graph is constructed that includes relevant label semantic information. The unified label graph advantageously unifies structured knowledge represented by a graph with unstructured knowledge given by label descriptions, thereby incorporating more adequate label semantics into text classification. The unified label graph advantageously models relations between labels explicitly, which can help to clarify subtle differences between two labels and identify exceptional sub-concepts under a label. In a second stage, a text classification model predicts an output label that should be applied to an input text using the unified label graph.

### FIELD

The device and method disclosed in this document relates to machine learning and, more particularly, to text classification using co-attentive fusion with a unified graph representation.

### BACKGROUND

Unless otherwise indicated herein, the materials described in this section are not admitted to be the prior art by inclusion in this section.

Text classification is the task of classifying input texts into pre-defined labels. One example of text classification is to classify newspaper articles into different categories, such as politics, economy, and sports. Text classification is an important task in natural language processing (NLP) with numerous applications such as sentiment analysis and information extraction. With the recent advancement of deep neural networks (DNNs), state-of-the-art text classification models often employ them to address the task. Text classification models based on DNNs normally require a large amount of training data (labelled texts) in order to achieve a good performance. However, the training data may be limited in practice because manual labelling of texts is often expensive and time-consuming, especially in special domains requiring extensive domain expertise.

This low-resource issue is partly caused by the unnatural form of standard classification training. FIG. 6 shows an exemplary conventional text classification model 500. An input text 540 is provided to a text encoder 532, which generates a text embedding 542. The text embedding 542 is provided to a classifier 536, which predicts an output label 550. In a supervised training process, the output label 550 is compared with a ground truth label for the input text 540. Models adopting this architecture typically ignore what labels mean, and simply learn a good mapping function that maps an input text 540 to its corresponding ground truth label. This observation is supported by the fact that the same classification performance is achieved by those models even if we replace labels to meaningless symbols, such as class1, class2, etc. On the other hand, if we humans are asked to classify certain texts to labels, we are likely to utilize knowledge about labels (e.g., politics, economy, and sports) and could quickly find the correct labels without much training. Therefore, learning the text-to-label mapping function while ignoring label semantics can be considered an unnatural form of text classification training, and one side effect of the ignorance of label semantics is that training requires an unnecessarily large amount of training data.

Some prior works have explored incorporating label semantic information. FIG. 7 shows an exemplary text classification model 600 that attempts to incorporate some label semantic information. An input text 640 is provided to a text encoder 632, which generates a text embedding 642. Additionally, a label set 612 is provided to a label encoder 634, which generates label embeddings 622. The text embedding 642 and the label embeddings 622 are provided to a similarity calculator 636 that compares the text embedding 642 and the label embeddings 622 to predict an output label 650. Although this technique incorporates some label semantic information, the amount of incorporated label semantic information is quite limited. Moreover, the modelled interactions between input texts and labels are shallow and thus not adequate for robust text classification.

### SUMMARY

A method for training a text classification model is disclosed. The method comprises receiving, with a processor, text data as training input. The method further comprises receiving, with the processor, a label graph. The label graph represents semantic relations between a plurality of labels. The label graph includes nodes connected by edges. The method further comprises applying, with the processor, a text encoder of the text classification model to determine a text representation representing the text data. The method further comprises applying, with the processor, a graph encoder of the text classification model to determine a label graph representation representing the label graph. The method further comprises applying, with the processor, a graph neural network of the text classification model to determine an output label and a training loss, based on the text representation and the label graph representation. The method further comprises refining, with the processor, the text classification model based on the training loss.

A method for classifying text data is disclosed. The method comprises receiving, with a processor, text data. The method further comprises receiving, with the processor, a label graph representation representing a label graph. The label graph represents semantic relations between a plurality of labels. The label graph includes nodes connected by edges. The method further comprises applying, with the processor, a text encoder of the text classification model to determine a text representation representing the text data. The method further comprises applying, with the processor, a graph neural network of the text classification model to determine a classification label of the text data, based on the text representation and the label graph representation.

### BRIEF DESCRIPTION OF THE DRAWINGS

The foregoing aspects and other features of the methods and systems are explained in the following description, taken in connection with the accompanying drawings.

FIG. 1 is a high-level diagram of a text classification framework.

FIG. 2 shows an exemplary embodiment of the computing device that can be used to train a text classification model.

FIG. 3 shows a flow diagram for a method for training a text classification model configured to determine a classification label for an input text.

FIG. 4 shows an exemplary unified label graph.

FIG. 5 shows a table including labels, annotation guidelines, and domain knowledge for a text classification task in the automotive repair domain.

FIG. 6 shows an exemplary conventional text classification model.

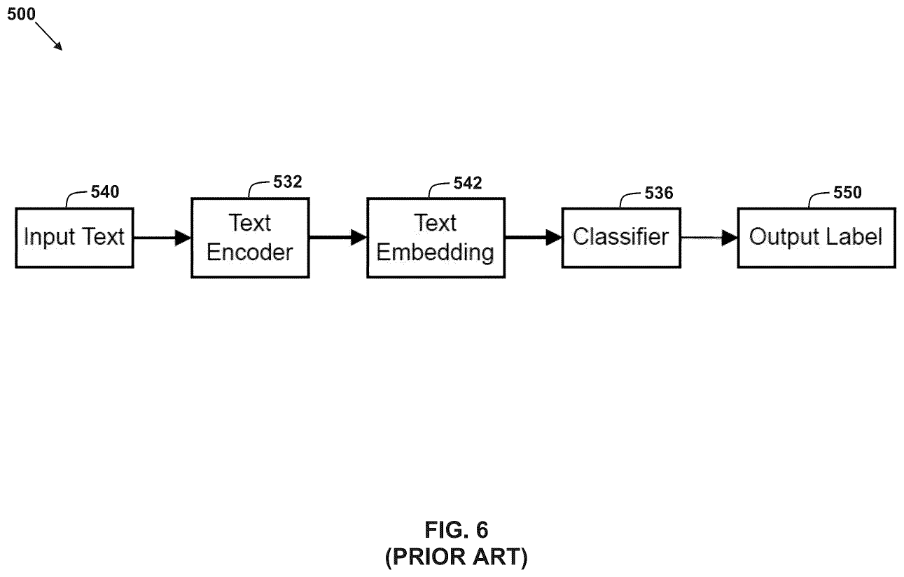

FIG. 7 an exemplary text classification model that incorporates some label semantic information.

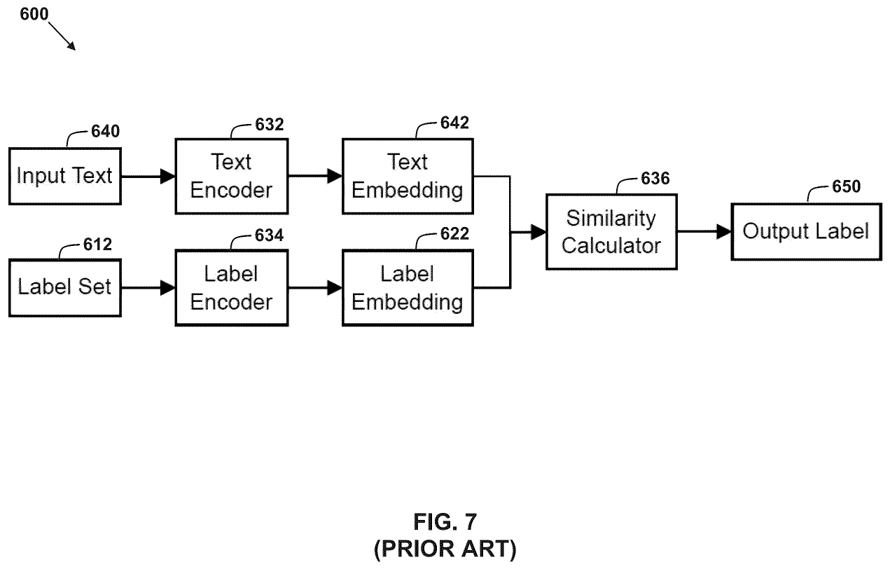

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art which this disclosure pertains.

### Overview

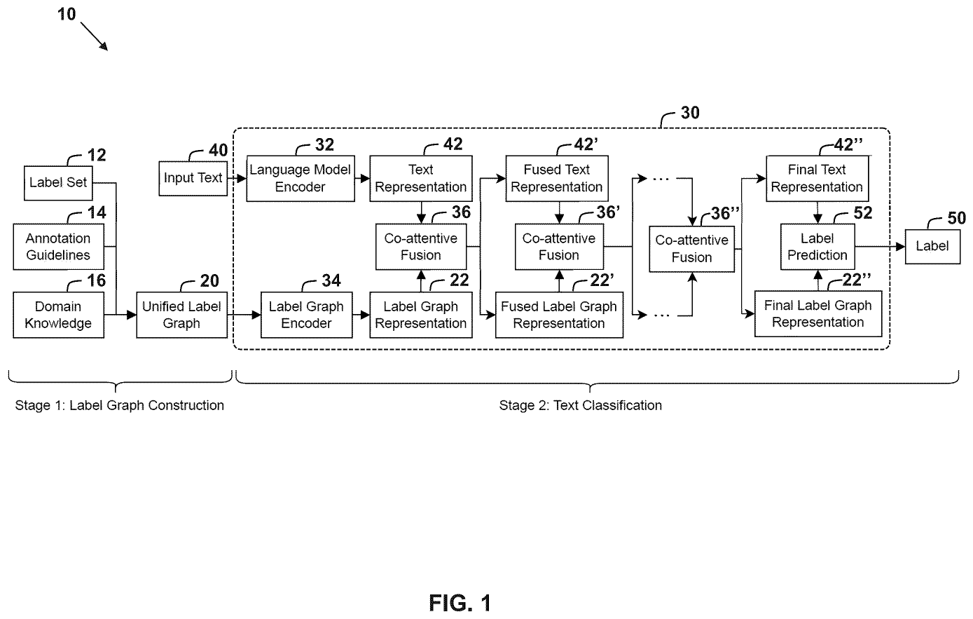

FIG. 1 is a high-level diagram of a text classification framework 10 according to the disclosure. The text classification framework 10 may be referred to as Co-attentive Fusion with Unified Label Graph Representation (CoFuLaG). As illustrated in FIG. 1, the text classification framework 10 is a two-stage process. In a first stage, a unified label graph 20 is constructed that includes relevant label semantic information. The unified label graph 20 advantageously unifies structured knowledge represented by a graph with unstructured knowledge given by label descriptions, thereby incorporating more adequate label semantics into text classification. The unified label graph 20 advantageously models relations between labels explicitly, which can help to clarify subtle differences between two labels and identify exceptional sub-concepts under a label.

In at least some embodiments, unified label graph 20 is constructed manually by human experts. Thus, the text classification framework 10 advantageously allows human experts to refine label semantic information in a flexible and human-understandable manner through the unified label graph 20 in order to make informative predictions in text classification. Particularly, the unified label graph 20 can be created with the assistance of human experts which can enable more efficient and effective integration of domain know-how or even common-sense knowledge. By incorporating rich label semantic information into the text classification, the text classification framework 10 mitigates the low-resource issue discussed above.

With continued reference to FIG. 1, in a second stage, a text classification model 30 predicts an output label 50 that should be applied to an input text 40. The text classification model 30 makes inferences based on the input text 40, using the unified label graph 20. The text classification framework 10 incorporates rich label semantic information through the unified label graph 20 and intensively fuses a representation of the input text 40 with representations of the unified label graph 20 to make predictions of the output label 50. It should be appreciated that the framework 10 can be easily extended to multi-label classification cases where each text input is assigned to multiple labels, but the disclosure focuses on single-label classification for simplicity.

As will be described in greater detail below, the text classification model 30 leverages a multi-layer graph neural network (GNN) and a co-attention mechanism to achieve the intensive fusion of the representation of the input text 40 and the representations of the unified label graph 20. This intensive fusion not only encourages better learning both representations but also enables more adequate interactions between the input text 40 and the unified label graph 20.

### Exemplary Hardware Embodiment

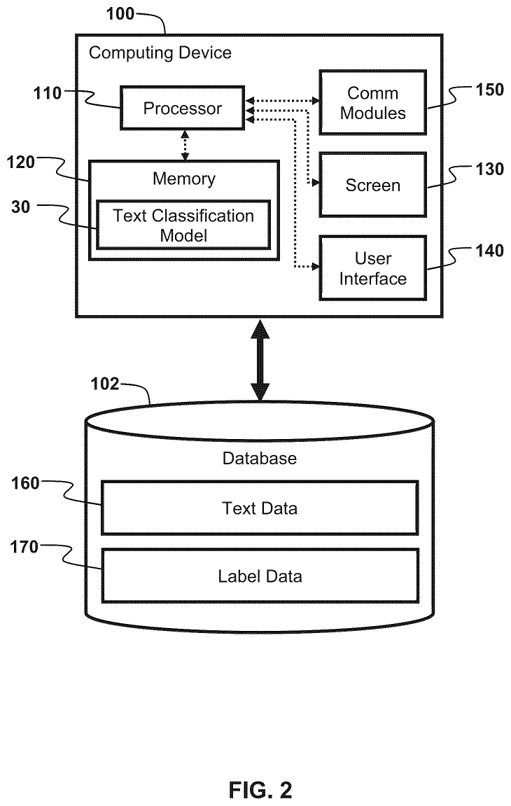

FIG. 2 shows an exemplary embodiment of the computing device 100 that can be used to train the text classification model 30 for determining a classification label for an input text. Likewise, the computing device 100 may be used to operate a previously text classification model 30 to determine a classification label for an input text. The computing device 100 comprises a processor 110, a memory 120, a display screen 130, a user interface 140, and at least one network communications module 150. It will be appreciated that the illustrated embodiment of the computing device 100 is only one exemplary embodiment is merely representative of any of various manners or configurations of a server, a desktop computer, a laptop computer, mobile phone, tablet computer, or any other computing devices that are operative in the manner set forth herein. In at some embodiments, the computing device 100 is in communication with a database 102, which may be hosted by another device or which is stored in the memory 120 of the computing device 100 itself.

The processor 110 is configured to execute instructions to operate the computing device 100 to enable the features, functionality, characteristics and/or the like as described herein. To this end, the processor 110 is operably connected to the memory 120, the display screen 130, and the network communications module 150. The processor 110 generally comprises one or more processors which may operate in parallel or otherwise in concert with one another. It will be recognized by those of ordinary skill in the art that a “processor” includes any hardware system, hardware mechanism or hardware component that processes data, signals or other information. Accordingly, the processor 110 may include a system with a central processing unit, graphics processing units, multiple processing units, dedicated circuitry for achieving functionality, programmable logic, or other processing systems.

The memory 120 is configured to store data and program instructions that, when executed by the processor 110, enable the computing device 100 to perform various operations described herein. The memory 120 may be of any type of device capable of storing information accessible by the processor 110, such as a memory card, ROM, RAM, hard drives, discs, flash memory, or any of various other computer-readable medium serving as data storage devices, as will be recognized by those of ordinary skill in the art.

The display screen 130 may comprise any of various known types of displays, such as LCD or OLED screens, configured to display graphical user interfaces. The user interface 140 may include a variety of interfaces for operating the computing device 100, such as buttons, switches, a keyboard or other keypad, speakers, and a microphone. Alternatively, or in addition, the display screen 130 may comprise a touch screen configured to receive touch inputs from a user.

The network communications module 150 may comprise one or more transceivers, modems, processors, memories, oscillators, antennas, or other hardware conventionally included in a communications module to enable communications with various other devices. Particularly, the network communications module 150 generally includes an ethernet adaptor or a Wi-Fi® module configured to enable communication with a wired or wireless network and/or router (not shown) configured to enable communication with various other devices. Additionally, the network communications module 150 may include a Bluetooth® module (not shown), as well as one or more cellular modems configured to communicate with wireless telephony networks.

In at least some embodiments, the memory 120 stores program instructions of the text classification model 30 that, once the training is performed, is configured to determine a classification label for an input text. In at least some embodiments, the database 102 stores a plurality of text data 160 and plurality of label data 170. The plurality of label data includes at least one unified label graph, and may further include label descriptions for a plurality of labels and example texts for each of the plurality of labels.

### Method of Training a Text Classification Model

A variety of operations and processes are described below for operating the computing device 100 to develop and train the text classification model 30 for determining a classification label for an input text. In these descriptions, statements that a method, processor, and/or system is performing some task or function refers to a controller or processor (e.g., the processor 110 of the computing device 100) executing programmed instructions stored in non-transitory computer readable storage media (e.g., the memory 120 of the computing device 100) operatively connected to the controller or processor to manipulate data or to operate one or more components in the computing device 100 or of the database 102 to perform the task or function. Additionally, the steps of the methods may be performed in any feasible chronological order, regardless of the order shown in the figures or the order in which the steps are described.

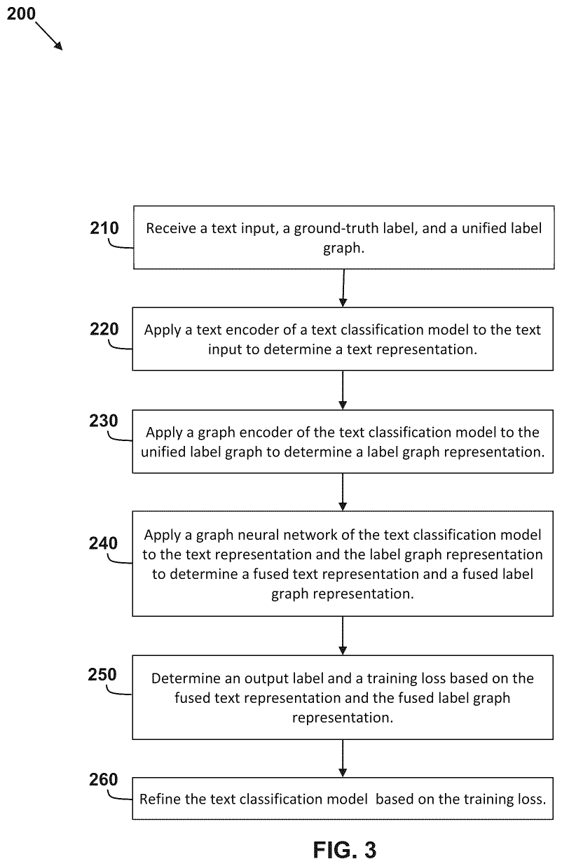

FIG. 3 shows a flow diagram for a method 200 for training a text classification model configured to determine a classification label for an input text. The method 200 advantageously leverages the unified label graph 20 to unify structured knowledge represented by a graph with unstructured knowledge given by label descriptions, thereby incorporating more adequate label semantics into text classification. The text classification model 30 is advantageously trained to make inferences based on the input text 40, using the unified label graph 20. The text classification model 30 leverages an intensive fusion process that not only encourages better learning but also enables more adequate interactions between the input text 40 and the unified label graph 20.

The method 200 begins with receiving a text input, a ground-truth label, and a unified label graph (block 210). Particularly, the processor 110 receives and/or the database 102 stores a plurality of labeled texts D={xₖ, yₖ}ₖ₌₁^{N}. Each label text includes a training text xₖ and an associated ground truth label yₖ∈C, where xₖ is the k-th training text, yₖ∈C is its corresponding label, C is a set of pre-defined labels {c₁, c₂, . . . , c_{|c|}}, and N is the total number of labeled texts in the set D. The textual unit of xₖ can be a sentence, a paragraph, or a document which comprises a sequence of tokens: xₖ=wₖ₁wₖ₂ . . . . w_{k|x}_{ₖ}_{|}. In general, the number N of labeled texts in the plurality of labeled texts D is small compared to those required for conventional text classification models, such that the dataset can be constructed by manual labelling of texts in a low-resource setting and with low costs.

Additionally, the processor 110 the processor 110 receives and/or the database 102 stores a unified label graph [symbol] _{C} constructed from a set of pre-defined labels C={c₁, c₂, . . . , c_{|c|}}. The unified label graph [symbol] _{C} is constructed from the label set C and other information about the labels, prior to training the text classification model 30 using the method 200. With reference to FIG. 1, the unified label graph 20 (i.e., [symbol] _{C}) is generated based on a label set 12 (i.e., C), annotation guidelines 14, and domain knowledge 16.

For a better understanding of the problems that might be solved using the unified label graph [symbol] _{C}, the methods are described with respect to the illustrative example in the automotive repair domain. However, it should be appreciated that the systems and methods described herein can be applied to any domain and the references herein to the automotive repair domain and terminologies thereof should be understood to be merely exemplary.

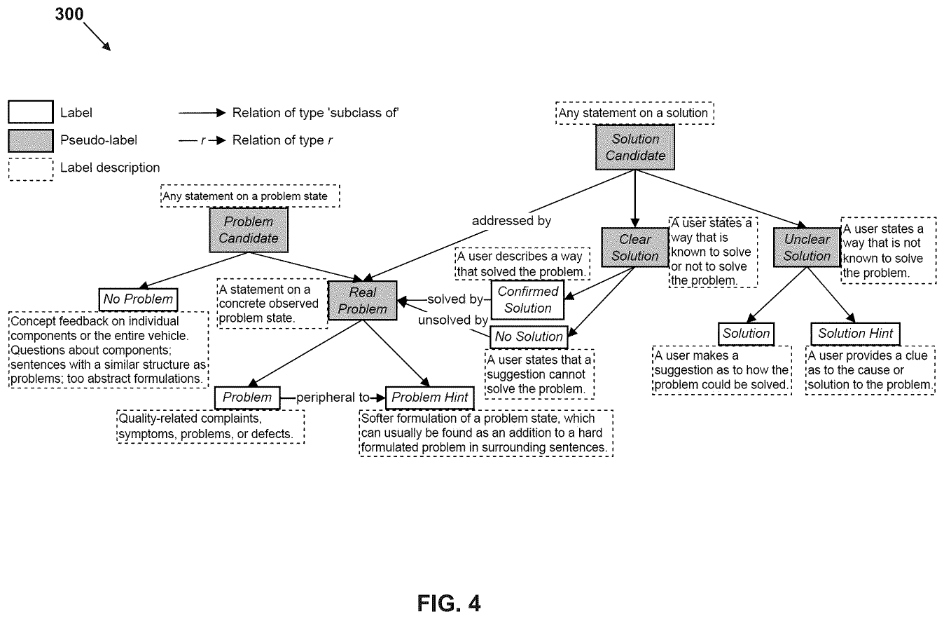

FIG. 4 shows an exemplary unified label graph 300 in the automotive repair domain. Each node in the exemplary unified label graph 300 represents either a label or a pseudo-label, associated with its description. Each edge in the exemplary unified label graph 300 represents a semantic relationship between labels. The goal of label graph construction is to build a unified label graph [symbol] _{C} containing rich label semantic information so that it can be used by the text classification model 30 to help to make informative predictions in text classification.

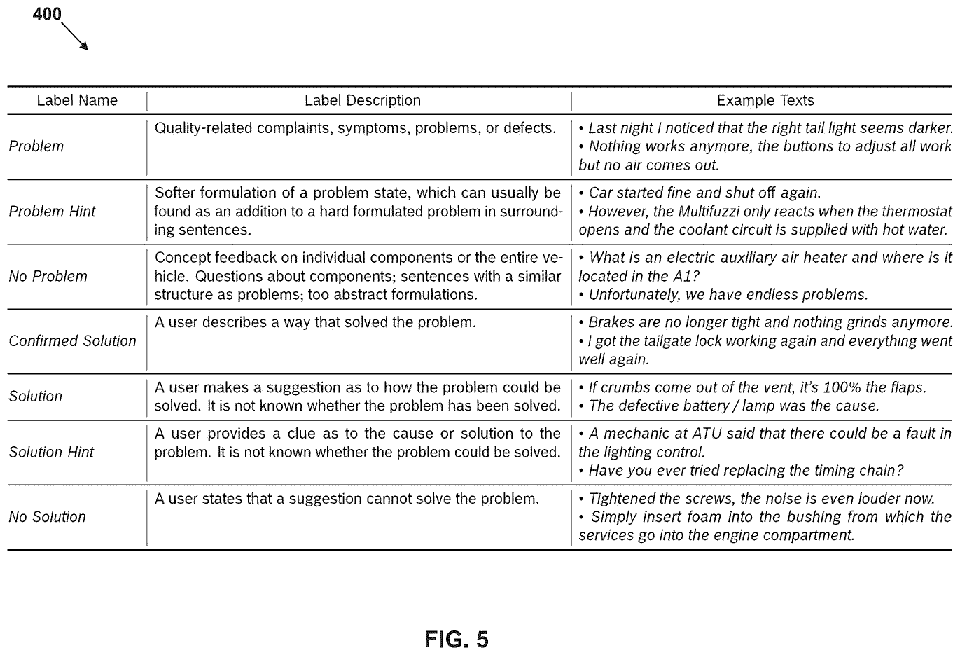

The exemplary unified label graph 300 was constructed for a text classification task in the automotive repair domain, based on the labels, annotation guidelines, and domain knowledge provided in the table 400 of FIG. 5. As can be seen in FIG. 5, seven different labels are provided in the left-most column (e.g., Problem, Problem Hint, No Problem, Confirmed Solution, Solution, Solution Hint, and No Solution). Thus, for this text classification task in the automotive repair domain, the label set C is formed as follows:

$$C = \{ Problem , Problem Hint , No Problem , \\ Confirmed Solution , Solution , , Solution Hint , No Solution \} . \qquad ( 1 )$$

Additionally, in the middle column of the table 400 of FIG. 5, each of the seven labels is provided with a label description, which is authored by a domain expert and provides annotation guidelines for applying the associated label to texts. Finally, in the right-most column of the table 400, example texts are provided and assigned to one of the seven labels. In the illustrated example, each example text is a single sentence, but the example texts could also comprise paragraphs or entire text documents, depending on the application.

In a unified label graph [symbol] _{C}, each node represents either a label (illustrated by a box) or a pseudo-label (illustrated by a shaded box). A pseudo-label is not a real label within the label set C (and was not included in the table 400), but serves as a placeholder that constitutes structural parts of label knowledge (e.g., label hierarchies). Thus, in addition to the set of labels C that are valid outputs of the text classification model 30, let C′={c′₁, c′₂, . . . , c′_{|c′|})} denote a set of pseudo-labels that are not valid outputs of the text classification model 30, but will nonetheless be used by the unified label graph [symbol] _{C}. Returning to FIG. 4, in addition to the labels in the set of labels C, the unified label graph 300 includes pseudo-labels Problem Candidate, Real Problem, Solution Candidate, Clear Solution, and Unclear Solution.

Additionally, in t a unified label graph [symbol] _{C}, each edge represents a relation between two labels or pseudo-labels. A unified label graph may include any number of types of relations between labels. In the example of FIG. 4, the unified label graph 300 includes ‘subclass of’ relation type (illustrated by a solid arrow) indicating that a label or pseudo-label is a subclass of another label or pseudo-label indicated by a solid arrow. For instance, in the unified label graph 300, a ‘subclass of’ relation is defined between two labels Problem and Real Problem, that is, Problem is a sub-class of Real Problem. Additionally, the unified label graph 300 includes additional domain-specific or task-specific relation types ‘peripheral to,’ ‘addressed by,’ ‘solved by,’ and ‘unsolved by’ (illustrate by an arrow with a relation description superimposed thereon) that indicate corresponding relations between a label or pseudo-label and another label or pseudo-label. For instance, in the unified label graph 300, a ‘peripheral to’ relation is defined between two labels Problem and Problem Hint, that is, Problem Hint is peripheral to Problem.

In addition to nodes and edges, a unified label graph [symbol] _{C} also associates a label description (illustrated as a dashed box) with its corresponding label. The label description is a textual explanation that describes and/or defines a label and provides additional information about it. Thus, let S={s₁, s₂, . . . , s_{|c|}} denote a set of label descriptions for the set of labels C and S′={s′₁, s′₂, . . . , s_{|c′|}} denote a set of pseudo-label descriptions for the set of pseudo-labels C′. In the set S, sᵢ is the label description of the label cᵢ and, in the set S′, s′ᵢ is the pseudo-label description of the pseudo-label c′ᵢ. For instance, in the unified label graph 300, the Real Problem label is associated with the label description “A statement on a concrete observed problem state.” By having a label description associated with each node, a unified label graph [symbol] _{C} offers richer label semantic information than a traditional knowledge graph where only nodes and edges are represented. For this reason, the label graph [symbol] _{C} is referred to herein as the ‘unified label graph’ because it combines structured knowledge represented by a graph with unstructured knowledge given by label descriptions.

Thus, the unified label graph [symbol] _{C} can be defined formally as [symbol] _{C}=( [symbol] ), where V=C∪C′ is the set of label nodes (vertices), [symbol] =S∪S′ is the set of label descriptions associated with each node in V, and ε⊂V× [symbol] ×V is the set of edges connecting labels with a relation type in [symbol] .

The unified label graph [symbol] _{C} plays two roles in the text classification framework 10. First, it serves as a human-understandable backbone knowledge base about the labels used in the text classification task. The unified label graph [symbol] _{C} can be viewed as a venue where human experts such as domain experts and knowledge engineers describe their own knowledge about labels in a flexible and collaborative manner. It provides not only additional information on individual labels but also cross-label information, e.g., clarifying subtle differences between a Problem and a Problem Hint.

Second, from the machine learning perspective, a unified label graph [symbol] _{C} provides additional high-level supervision to text classification model 30, which is useful especially in low-resource settings. By incorporating information in the unified label graph [symbol] _{C}, the text classification model 30 is made aware of important regularities labels directly expressed by the unified label graph [symbol] _{C}, upfront in the training phase. In contrast, a conventional text classification model that is trained ignorant of such label semantics from scratch will only learn such important regularities implicitly by way of hundreds or thousands of training examples, due to the implicit nature of the regularities in merely labeled training texts.

Although a variety of workflows might be adopted by human experts to construct the unified label graph [symbol] _{C}, one exemplary workflow to manually construct the unified label graph [symbol] _{C} is described here. In a first step (1), the human experts define the label set C as a part of V. In a second step (2), the human experts provide the set of label descriptions S for the label set C as a part of [symbol] . In a third step (3), the human experts identify a relation between two labels as a part of ε. If existing labels are not sufficient to identify the relation, then the human experts add a pseudo-label in C′ as a part of V and provide its corresponding label description in S′ as a part of [symbol] . The third step (3) is repeated until no further rations can be identified.

It is estimated that, in practice, that the cost of manually constructing the unified label graph [symbol] _{C} should be similar to the cost of manually creating annotation guidelines where a task designer describes label names and descriptions. The process of defining relations between labels, while introducing pseudo-labels into the unified label graph [symbol] _{C} as needed, may take some additional cost compared to only creating annotation guidelines. Nonetheless, in the case of a label set of a moderate size (e.g., 5-20), the total cost of manually constructing the unified label graph [symbol] _{C} is expected to be significantly lower than the cost of manually creating the hundreds or thousands of training examples that would be required to train a text classification model that is blind to semantic label information.

Returning to FIG. 3, the method 200 continues with applying a text encoder of a text classification model to the text input to determine a text representation (block 220). Particularly, with reference to FIG. 1, the text classification model 30 includes a language model encoder 32. The processor 110 executes the language model encoder 32 with the input text 40 (i.e., one of the training texts xₖ) as input to determine an initial text representation 42. In some embodiments, the processor 110 first determines a sequence of tokens representing the text. The tokens may represent individual words or characters in the input text 40. The processor 110 determines the initial text representation 42 as a sequence of vector representations, each vector representation representing a respective token from the sequence of tokens.

In some embodiments, the text classification model 30 adopts the encoder part of a pre-trained and pre-existing language model, such as BERT or ROBERTa, as the language model encoder 32. Given an input sequence of n tokens x=x₁, x₂ . . . . xₙ, the processor 110 computes d-dimensional contextualized representations H∈ [symbol] ^{n×d} at each layer. In one embodiment, each layer of the language model encoder 32 is a combination of a multi-head self-attention layer and a position-wise fully connected feed-forward layer. A contextualized representation for each position of x from the last layer is determined according to:

$$\{ {x}_{1}^{0} , … , {x}_{n}^{0} \} = {E}_{LM} ( {x}_{1} {x}_{2} … {x}_{n} ) , \qquad ( 2 )$$

where xₘ⁰ is a vector representation of the m-th token xₘ and 1≤m≤n.

In one embodiment, the processor 110 adds a special token <s> to the beginning of the text, i.e., x₁=<s>. For this special token, [CLS] may be used, as in the case of the BERT and ROBERTa models. The vector representation at <s> can be regarded as a text representation of x, denoted as the representation function E_{<z>}(x).

The initial text representation 42, e.g., X⁰={x₁⁰, . . . , xₙ⁰}, is the starting point of the input text representation. As discussed below, the initial text representation 42 will be iteratively fused with an initial label graph representation 22, using a co-attentive fusion process.

The method 200 continues with applying a graph encoder of the text classification model to the unified label graph to determine a label graph representation (block 230). Particularly, with reference to FIG. 1, the text classification model 30 includes a label graph encoder 34. The processor 110 executes the label graph encoder 34 with the unified label graph [symbol] _{C} as input to determine an initial label graph representation 22. In some embodiments, the processor 110 determines, for each node in the unified label graph [symbol] _{C}, a node embedding by encoding text describing the label represented by the node. The text describing the label may, for example, be a concatenation of a label name and a label description. In some embodiments, the processor 110 initializes a relation embedding for each respective type of semantic relation in the unified label graph [symbol] _{C} with a respective random value. In some embodiments, the processor 110 determines, for each edge in the unified label graph [symbol] _{C}, an edge embedding depending on a type of semantic relation represented by the edge. Particularly, the edge embedding is determined to be the relation embedding corresponding to the type of semantic relation represented by the respective edge.

As discussed above, each node in the unified label graph [symbol] _{C} may have both a label name and a textual description of the label associated therewith. In some embodiments, the processor 110 encodes these label names and label descriptions together as node embeddings. Given a label node cᵢ∈V and an edge of relation r∈ [symbol] , the processor 110 determines a set of node embeddings {cᵢ⁰, . . . , c_{|v|}⁰} and edge embeddings {rⱼᵢ, . . . , r|ε|} as follows:

$${c}_{i}^{0} = {E}_{〈 s 〉} ( {text}_{{c}_{i}} ) , \qquad ( 3 )$$

$$r = {T}_{r} , \qquad ( 4 )$$

where text_{c}_{ᵢ} denotes a concatenation of cᵢ's name and the description, i.e., cᵢsᵢ, and T∈ [symbol] are relation embeddings of the set of semantic relation types [symbol] . Given the set of semantic relation types [symbol] , the processor 110 may initialize the relation embedding Tᵣ for each type of semantic relation in [symbol] with a random value. The edge embedding rⱼᵢ for an edge connecting node j to node i is set to the value of the relation embedding Tᵣ.

The initial label graph representation 22, i.e . . . , C⁰={cᵢ⁰, . . . , c_{|v|}⁰)} and {rⱼᵢ, . . . , r_{|ε|}}, is the starting point of label graph representation. As discussed below, the initial label graph representation 22 will be iteratively fused with the initial text representation 42, using a co-attentive fusion process.

The method 200 continues with applying a graph neural network of the text classification model to the text representation and the label graph representation to determine a fused text representation and a fused label graph representation (block 240). Particularly, with reference to FIG. 1, the text classification model 30 includes a co-attentive fusion component 36, which includes a multi-layer graph neural network (GNN) with a co-attention mechanism. The processor 110 executes the co-attentive fusion component 36 to iteratively fuse the initial text representation 42 with the initial label graph representation 22 to determine a final text representation 42″ and a final label graph representation 22″, which models rich interactions between the input text 40 and the unified label graph 20.

The iterative fusion process of the co-attentive fusion component 36 includes a plurality of iterations that, in each case, determine an updated text representation and an updated label graph representation based on a previous text representation and a previous label graph representation. The final text representation 42″ and the final label graph representation 22″ are the updated text representation and the updated label graph representation, respectively, from a final iteration of the plurality of iterations of the co-attentive fusion component 36. Accordingly, as can be seen in FIG. 1, the processor 110 determines one or more intermediate fused text representations 42′ and one or more intermediate fused label graph representations 22′. Additionally, the co-attentive fusion component 36 consists of several layers 36, 36′, 36″ that perform the iterations of the co-attentive fusion.

The goal of co-attentive fusion is to model adequate interactions between the input text xₖ and the unified label graph [symbol] _{C}, thereby making a more informative prediction on the label of the text with label semantic knowledge. At a high level, the co-attentive fusion component 36 iteratively fuses an initial text representation X⁰ with an initial label graph representation C⁰ to determine a final text representation X^{L}={xₘ^{L}}ₘ₌₁ⁿ and a final label graph representation C^{L}={cᵢ^{L}}ᵢ₌₁^{|V|} according the iterative process:

$$\{ {X}^{L} , {C}^{L} \} = CoAttentiveFusion ( \{ {X}^{l - 1} , {C}^{l - 1} \} ) \qquad ( 5 )$$

where 1≤l≤L. After L iterations, the processor 110 obtains the final text representation X^{L} and the final label graph representation C^{L}.

Each iteration of co-attentive fusion begins with determining updated node embeddings {\tilde{c}₁^{l}, . . . , \tilde{c}_{|V|}^{l}} based the previous label graph representation C^{l-1}. Particularly, in at least one embodiment, the co-attentive fusion component 36 includes an L-layer GNN architecture based on R-GAT. For each iteration of the L iterations of equation (5), the label graph representation is provided directly to the GNN architecture, obtaining an updated label graph representation as follows:

$$\{ {\tilde{c}}_{1}^{l} , … , {\tilde{c}}_{\vert 𝒱 \vert}^{l} \} = GNN ( \{ {c}_{i}^{l - 1} , … , {c}_{\vert 𝒱 \vert}^{l - 1} \} ) . \qquad ( 6 )$$

This GNN layer of equation (6) computes the updated node embeddings \tilde{c}ᵢ^{l} as follows:

$${\hat{α}}_{ji} = ( {c}_{i}^{l - 1} {W}_{q} ) {( {c}_{j}^{l - 1} {W}_{k} + {r}_{ji} )}^{⊤} , \qquad ( 7 )$$

$${α}_{ji} = softmax ( {\hat{α}}_{ji} / \sqrt{d} ) , \qquad ( 8 )$$

$${\hat{c}}_{i}^{l - 1} = {\sum }_{j ∈ {N}_{i} ⋃ \{ i \}} {α}_{ji} ( {c}_{i}^{l - 1} {W}_{v} + {r}_{ji} ) , \qquad ( 9 )$$

$${\tilde{c}}_{i}^{l} = LayerNorm ( {c}_{i}^{l - 1} + {\hat{c}}_{i}^{l - 1} {W}_{0} ) , \qquad ( 10 )$$

where matrices W_{q}, Wₖ, Wᵥ, W₀ ∈ [symbol] ^{d×d} are trainable parameters, Nᵢ is the neighbors of node i, and rⱼᵢ is the edge embedding for the edge connecting node j to node i.

To compute the compatibility between input texts and labels, \tilde{c}ᵢ^{l} and xₘ^{l-1} are fused to obtain their updated (or “fused”) representations. Particularly, each iteration of co-attentive fusion continues with determining an affinity matrix Aₘᵢ^{l} indicating a similarity between the updated node embeddings {\tilde{c}₁^{l}, . . . , c_{|v|}^{l}} and the previous text representation X^{l-1}. Given \tilde{c}ᵢ^{l} and xₘ^{l-1}, the processor 110 constructs an affinity matrix Aₘᵢ^{l}∈ [symbol] ^{d×d} (also called a similarity matrix) for the l-th layer as follows:

$${A}_{mi}^{l} = {W}_{A} [ {x}_{m}^{l - 1} ; {\tilde{c}}_{i}^{l} ; {x}_{m}^{l - 1} ∘ {\tilde{c}}_{i}^{l} ] , \qquad ( 11 )$$

where W_{A} is a trainable weight matrix, [;] is the vector concatenation, and ∘ is the element-wise multiplication.

Next, each iteration of co-attentive fusion continues with determining an LG-to-text attention map Aₓ_{ₘ}^{l} and text-to-LG attention map A_{c}_{ᵢ}^{l}, by normalizing the affinity matrix Aₘᵢ^{l} across the row and column dimensions, respectively. Particularly, the processor 110 performs the row-wise normalization on Aₘᵢ^{l}∈ [symbol] ^{d×d}, thereby deriving the LG-to-text attention map over input text tokens conditioned by each label in the unified label graph [symbol] _{C}:

$${A}_{{x}_{m}}^{l} = softmax ( {A}_{mi}^{l} ) . \qquad ( 12 )$$

Similarly, the processor 110 also performs the column-wise normalization on Aₘᵢ^{l}∈ [symbol] ^{d×d}, thereby deriving text-to-LG attention map over labels conditioned by each input token in the input text xₖ:

$${A}_{{c}_{i}}^{l} = softmax ( {A}_{mi}^{{l}_{⊤}} ) . \qquad ( 13 )$$

Next, each iteration of co-attentive fusion continues with determining attended text representations \hat{x}ₘᵢ based on the previous text representation xₘ^{l-1} using the LG-to-text attention map Aₓ_{ₘ}^{l} and determining attended label graph representations îₘᵢ based on the updated node embeddings \tilde{c}ᵢ^{l} using the text-to-LG attention map A_{c}_{ᵢ}^{l}. Particularly, the processor 110 computes the attended text representations \hat{x}ₘᵢ and the attended label graph representations ĉₘᵢ as follows:

$${\hat{x}}_{mi} = {x}_{m}^{l - 1} ⊗ {A}_{{x}_{m}}^{l} , \qquad ( 14 )$$

$${\hat{c}}_{mi} = {\tilde{c}}_{i}^{l} ⊗ {A}_{{c}_{i}}^{l} , \qquad ( 15 )$$

where ⊗ is the matrix multiplication.

Finally, each iteration of co-attentive fusion concludes with determining the updated text representation xₘ^{l} and the updated label graph representation cᵢ^{l}. The updated text representation xₘ^{l} is determined based on the previous text representation xᵢ^{l-1}, the attended text representation \hat{x}ₘᵢ, and the attended label graph representation \hat{x}ₘᵢ. The updated label graph representation cᵢ^{l} is determined based on the updated node embeddings ĉᵢ^{l}, the attended label graph representation ĉₘᵢ, and the attended text representation \hat{x}ₘᵢ. Particularly, the processor 110 fuses the attended representations with the original representations of the counterpart by concatenation and projects them to a low-dimensional space to arrive at the updated (or “fused”) text representations xₘ^{l} and the updated (or “fused”) label graph representations cᵢ^{l} as follows:

$${x}_{m}^{l} = {W}_{x} [ {x}_{i}^{l - 1} ; {\hat{c}}_{mi} ; {x}_{i}^{l - 1} ∘ {\hat{c}}_{mi} ; {x}_{i}^{l - 1} ∘ {\hat{x}}_{mi} ] , \qquad ( 16 )$$

$${c}_{i}^{l} = {W}_{c} [ {\tilde{c}}_{i}^{l} ; {\hat{x}}_{mi} ; {\tilde{c}}_{i}^{l} ∘ {\hat{x}}_{mi} ; {\tilde{c}}_{i}^{l} ∘ {\hat{c}}_{mi} ] . \qquad ( 17 )$$

where Wₓ and W_{c} are also trainable weights.

The values xₘ^{l} and cᵢ^{l} from equations (16) and (17) are the outputs of the l-th iteration of the co-attentive fusion and/or l-th layer of the GNN. Thus, the processes of equations (6)-(17) specify the operations the iterative equation (5) and are repeated L times to achieve L iterations. After L layers of iteration, the processor 110 obtains the final fused text representation X^{L}={xₘ^{L}}ₘ₌₁ⁿ and the final fused label graph representation C^{L}={cᵢ^{L} }ᵢ₌₁^{|V|}, as described above. These representations fuse the knowledge from the counterpart representations, thereby making text classification predictions more informative.

The method 200 continues with determining an output label and a training loss based on the fused text representation and the fused label graph representation (block 250). Particularly, once the final text representation X^{L} and the final label graph representation C^{L} are determined, the processor 110 determines the output label 50 based on the final text representation X^{L} and the final label graph representation C^{L}. using a label prediction component 52 of the text classification model 30.

In some embodiments, since pseudo-labels cannot be the correct label, the processor 110 modifies the final label graph representation C^{L} to remove node embeddings representing the set of pseudo-labels C′ in the label graph that are not valid outputs of the text classification model 30, resulting in C^{L}={cᵢ^{L}}ᵢ₌₁^{|C|}.

In some embodiments, the processor 110 determines the output label 50 using a multi-layer perceptron (MLP) applied to the final text representation X^{L} and the (modified) final label graph representation C^{L} Particularly, the processor 110 computes the probability of label c E C being the correct label using a classifier based on MLP:

$$\hat{y} = softmax ( MLP ( {pool}_{mean} ( {X}^{L} ) ; {pool}_{mean} ( {C}_{C}^{L} ) ) ) , \qquad ( 18 )$$

where pool is the mean pooling. The predicted label is: ŷ=argmax ŷ.

For training, the processor 110 determines a training loss [symbol] based on the output label y and a ground truth label y associated with the text data. Particularly, the processor 110 computes the training loss [symbol] as a cross-entropy loss for ŷ:

$$ℒ = - {\sum }_{( x , y ) ∈ D} log {\hat{y}}_{\vert \hat{y} = y \vert} . \qquad ( 19 )$$

The method 200 continues with refining the text classification model based on the training loss (block 260). Particularly, during each training cycle, the processor 110 refines the text classification model 30 based on the training loss [symbol] . In at least some embodiments, during such the refinement process, the model parameters (e.g., model coefficients, machine learning model weights, etc.) of the text classification model 30 are modified or updated based on the training loss [symbol] (e.g., using stochastic gradient descent or the like).

Finally, it should be appreciated that, once the text classification model 30 has been trained, it can be used for classifying new texts. Utilizing the trained text classification model 30 to classify new texts operates with a fundamentally similar process to the method 200. Accordingly, the process is not described again in complete detail. In summary, the processor 110 receives new text data and determines the initial text representation 42. Likewise, the processor 110 receives the unified label graph [symbol] _{C} and determines the initial label graph representation 22. Alternatively, the processor 110 simply receives the initial label graph representation 22, which has been previously determined and stored in the memory 120. The processor 110 determines an output classification label 50 by applying the trained text classification model 30 in the manner discussed above with respect to the method 200. In this manner, the trained text classification model 30 can be used to classify new texts, after having been trained with a relatively small number of training inputs, as discussed above.

Embodiments within the scope of the disclosure may also include non-transitory computer-readable storage media or machine-readable medium for carrying or having computer-executable instructions (also referred to as program instructions) or data structures stored thereon. Such non-transitory computer-readable storage media or machine-readable medium may be any available media that can be accessed by a general purpose or special purpose computer. By way of example, and not limitation, such non-transitory computer-readable storage media or machine-readable medium can comprise RAM, ROM, EEPROM, CD-ROM or other optical disk storage, magnetic disk storage or other magnetic storage devices, or any other medium which can be used to carry or store desired program code means in the form of computer-executable instructions or data structures. Combinations of the above should also be included within the scope of the non-transitory computer-readable storage media or machine-readable medium.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

What is claimed is:

1. A method for training a text classification model, the method comprising:
receiving, with a processor, text data as training input;
receiving, with the processor, a label graph, the label graph representing semantic relations between a plurality of labels, the label graph including nodes connected by edges;
applying, with the processor, a text encoder of the text classification model to determine a text representation representing the text data;
applying, with the processor, a graph encoder of the text classification model to determine a label graph representation representing the label graph;
applying, with the processor, a graph neural network of the text classification model to determine an output label and a training loss, based on the text representation and the label graph representation; and
refining, with the processor, the text classification model based on the training loss.

2. The method according to claim 1, wherein (i) each respective node of the label graph represents a respective label from a plurality of labels and (ii) each respective edge of the label graph represents a semantic relation between the respective labels represented by the nodes connected by the respective edge.

3. The method according to claim 2, wherein the plurality of labels includes a subset of labels that are valid outputs of the text classification model and a subset of labels that are not valid outputs of the text classification model.

4. The method according to claim 2, wherein the label graph further includes label descriptions associated with respective nodes of the label graph, each label description including text data that describes the label represented by the associated node of the label graph.

5. The method according to claim 2, wherein edges of the label graph represent at least two different types of semantic relations.

6. The method according to claim 1, the applying the text encoder further comprising:
determining a sequence of tokens representing the text data; and
determining the text representation as a sequence of vector representations, each vector representation representing a respective token from the sequence of tokens.

7. The method according to claim 1, the applying the graph encoder further comprising:
determining, for each respective node in the label graph, a node embedding by encoding text describing the label represented by the respective node.

8. The method according to claim 7, wherein text describing the label represented by the respective node is a concatenation of a label name and a label description.

9. The method according to claim 1, the applying the graph encoder further comprising:
determining, for each respective edge in the label graph, an edge embedding depending on a type of semantic relation represented by the respective edge.

10. The method according to claim 9, the applying the graph encoder further comprising:
initializing a relation embedding for each respective type of semantic relation in a plurality of types of semantic relations as a respective random value,
determining, for each respective edge in the label graph, the edge embedding as the relation embedding corresponding to the type of semantic relation represented by the respective edge.

11. The method according to claim 1, the applying the graph neural network further comprising:
iteratively updating the text representation and the label graph representation with the graph neural network to determine a final text representation and a final label graph representation; and
determining the output label based on the final text representation and the final label graph representation.

12. The method according to claim 11, wherein the iteratively updating includes a plurality of iterations that each determine an updated text representation and an updated label graph representation based on a previous text representation and a previous label graph representation, the final text representation and the final label graph representation being the updated text representation and the updated label graph representation, respectively, from a final iteration of the plurality of iterations.

13. The method according to claim 12, each iteration in the plurality of iterations comprising:
determining updated node embeddings based on the previous label graph representation;
determining an affinity matrix indicating a similarity between the updated node embeddings and the previous text representation;
determining the updated text representation based on the previous text representation and the affinity matrix; and
determining the updated label graph representation based on the updated node embeddings and the affinity matrix.

14. The method according to claim 13, each iteration in the plurality of iterations comprising:
determining an attended text representation based on the previous text representation and the affinity matrix;
determining an attended label graph representation based on the updated node embeddings and the affinity matrix;
determining the updated text representation based on the previous text representation, the attended text representation, and the attended label graph representation; and
determining the updated label graph representation based on the updated node embeddings, the attended label graph representation, and the attended text representation.

15. The method according to claim 14, the determining the attended text representation further comprising:
determining a first attention map by performing a normalization of the affinity matrix along a first dimension; and
determining the attended text representation based on the previous text representation and the first attention map.

16. The method according to claim 14, the determining the attended label graph representation further comprising:
determining a second attention map by performing a normalization of the affinity matrix along a second dimension; and
determining the attended label graph representation based on the updated node embeddings and the second attention map.

17. The method according to claim 11, the determining the output label further comprising:
determining the output label using a multi-layer perceptron applied to the final text representation and the final label graph representation.

18. The method according to claim 11, the determining the output label further comprising:
modifying the final label graph representation to remove node embeddings representing a subset of labels represented in the label graph that are not valid outputs of the text classification model.

19. The method according to claim 11, the applying the graph neural network further comprising:
determining the training loss based on the output label and a ground truth label associated with the text data.

20. A method for classifying text data, the method comprising:
receiving, with a processor, text data;
receiving, with the processor, a label graph representation representing a label graph, the label graph representing semantic relations between a plurality of labels, the label graph including nodes connected by edges;
applying, with the processor, a text encoder of the text classification model to determine a text representation representing the text data; and
applying, with the processor, a graph neural network of the text classification model to determine a classification label of the text data, based on the text representation and the label graph representation.
